(19) United States
(12) Patent Application Publication
(10) Pub. No.: US 2012/0293491 A1
(43) Pub. Date: Nov. 22, 2012

(54) 3-D TOUCH SENSOR AND 3-D TOUCH PANEL

(75) Inventors: YUNG-CHEN WANG, Hsinchu (TW); TSUN-YI CHEN, Hsinchu (TW); RONG-SHUN CHEN, Hsinchu (TW); CHENG-YAO LO, Hsinchu (TW)

(73) Assignee: NATIONAL TSING HUA UNIVERSITY, Hsinchu (TW)

(21) Appl. No.: 13/180,701

(22) Filed: Jul. 12, 2011

(30) Foreign Application Priority Data
May 20, 2011 (TW) 100117733

(51) Int. Cl. G06T 15/00

(52) U.S. Cl. 345/419

(57) ABSTRACT

A 3-D touch panel includes a 3-D touch sensor, a capacitance sensing unit electrically connected to the 3-D touch sensor, and a processing unit electrically connected to capacitance sensing unit. The 3-D touch sensor includes a flexible substrate, a flexible plane, a first electrode, and a second electrode. The flexible plane is configured on the flexible substrate and used for a user to touch thereon. The first electrode and the second electrode are correspondingly and respectively configured on the flexible substrate and the flexible plane, and a capacitance is formed between the first electrode and the second electrode. The capacitance sensing unit is used for sensing the value of the capacitance, and the processing unit calculates the shearing force, which the user applies on the flexible plane, according to the difference of the capacitance value.

### BACKGROUND OF THE INVENTION

1. Field of the Invention

The present invention relates to a 3-D touch sensor and a 3-D touch panel, and more particularly, a 3-D touch sensor and a 3-D touch panel utilized in a stereoscopic display.

2. Description of the Prior Art

With the electronics industry developed, the touch panel with display is widely used in various electronic devices to meet consumer's demand, such as a variety of smart phones and data processors. The touch technology can be divided into single-touch or multi-touch, the system controls the electronic device through the touch panel detecting the one-dimensional point or the two-dimensional trajectory formed by a finger or a touch pen.

On the other hand, in order to meet consumer's demand for visual, the type of display gradual shift from 2-D flat display into 3-D stereoscopic display. The types of 3-D stereoscopic display can be broadly classified as the way of using human parallax and the way of using stereoscopic projection. The way of using human parallax is to generate two identical 2-D images in the plane, and utilize the parallax of human eyes to make the human brain combine the 2-D images to form the stereoscopic images. In general, such a 3-D display requires the assistance of 3-D glasses or other aids in order to reach a good 3-D effect. The way of using stereoscopic projection is to project the stereoscopic image on the three-dimensional space, the consumer can observe the 3-D image without using other aids, so the technology of this way is also called the bare-eyed 3-D technology.

The prior art of two-dimensional touch is suitable for the two-dimensional display. However, the 3-D display will be the developing trend in the future, wherein the 3-D display with stereoscopic projection projects the stereoscopic image on the three-dimensional space, so the prior art of two-dimensional touch does not fully meet the control of three-dimensional display.

### SUMMARY OF THE INVENTION

One scope of the present invention is to provide a 3-D touch sensor, which is suitable for the touch of a 3D stereoscopic display.

According to an embodiment of the present invention, the 3-D touch sensor of the present invention comprises a flexible substrate, a flexible plane, a support structure, a first electrode and a second electrode. The flexible plane is configured on the flexible substrate for a user to touch thereon. The support structure is configured between the flexible plane and the flexible substrate for forming a space between the flexible plane and the flexible substrate. The first electrode is configured on the flexible substrate, the second electrode is configured on the flexible plane relative to the first electrode. The polarity of the second electrode and the polarity of the first electrode are different to each other, therefore, a capacitance is formed between the first electrode and the second electrode. A user touches the flexible plane, and a shearing force applied by the user deforms the flexible plane and displaces the second electrode, and the capacitance value is changed between the first electrode and the second electrode.

Another scope of the present invention is to provide a 3-D touch panel, which is suitable for the touch of a 3-D stereoscopic display.

According to another embodiment of the present invention, the 3-D touch panel of the present invention comprises a flexible substrate, a flexible plane, a support structure, a first electrode, a second electrode a capacitance sensing unit and a processing unit. The flexible plane is configured on the flexible substrate for a user to touch thereon. The support structure is configured between the flexible plane and the flexible substrate for forming a space between the flexible plane and the flexible substrate. The first electrode is configured on the flexible substrate, the second electrode is configured on the flexible plane relative to the first electrode. The polarity of the second electrode and the polarity of the first electrode are different to each other, therefore, a capacitance is formed between the first electrode and the second electrode. A user touches the flexible plane, and a shearing force applied by the user deforms the flexible plane and displaces the second electrode, and the capacitance value is changed between the first electrode and the second electrode. The capacitance sensing unit is electrically connected to the first electrode and the second electrode for sensing the value of the first capacitance. The processing unit is electrically connected to the capacitance sensing unit for receiving the capacitance value measured by the capacitance sensing unit, and calculates a shearing force on the flexible plane applied by the user according to the difference of the capacitance value and an algorithm.

The 3-D touch sensor and 3-D touch panel of the present invention are capable of measuring the shearing force on the contact surface. In other words, the 3-D touch sensor and the 3-D touch panel of the present invention are capable of providing a touch sensing with more dimensions than the positive force, therefore, the 3-D touch sensor and the 3-D touch panel are suitable for the touch of a 3-D stereoscopic display with stereographic projection.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1 is a schematic sectional diagram of the 3-D touch sensor of an embodiment of the present invention.

FIG. 2 is a schematic sectional diagram of the 3-D touch sensor of FIG. 1 applied a shearing force.

FIG. 3 is a schematic sectional diagram of the 3-D touch sensor of another embodiment of the present invention.

FIG. 4 is a schematic sectional diagram of the 3-D touch sensor of another embodiment of the present invention.

FIG. 5 is a schematic sectional diagram of the 3-D touch sensor of another embodiment of the present invention.

FIG. 6 is a schematic sectional diagram of the 3-D touch panel of another embodiment of the present invention.

FIG. 7 is a schematic sectional diagram of the bump of the 3-D touch panel of FIG. 6 contacted by a user.

### DETAILED DESCRIPTION OF THE INVENTION

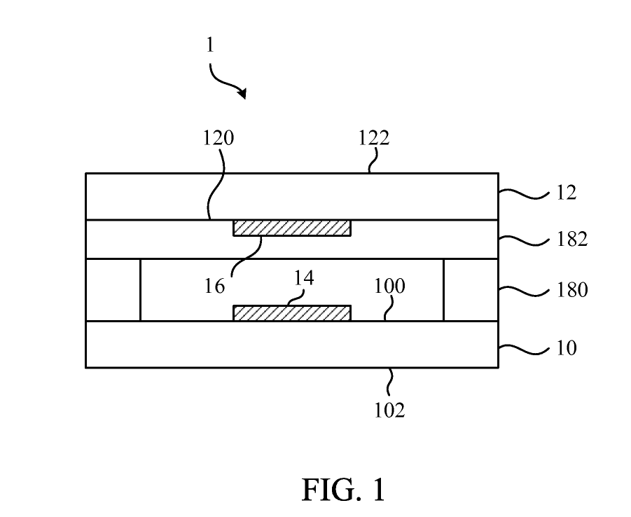

Please refer to FIG. 1. FIG. 1 is a schematic sectional diagram of the 3-D touch sensor of an embodiment of the present invention. As shown in FIG. 1, the 3-D touch sensor 1 comprises a flexible substrate 10, a flexible plane 12, a first electrode 14, a second electrode 16 and a support structure 180, wherein the flexible substrate 10 has a first surface 100 and a second surface 102 relative to the first surface 100, the flexible plane 12 has a third surface 120 and a contact surface 122 relative to the third surface v120. The flexible plane 12 is configured on the flexible substrate 10, and the third surface 120 is faced to the first surface 100 of the flexible substrate 10. In actual practice, a user can touch the contact surface 122 by a finger or a touch pen.

In the embodiment of the present invention, the first electrode 14 is configured on the first surface 100 of the flexible substrate 10, the second electrode 16 is configured on the third surface 120 of the flexible plane 12 relative to the first electrode 14. The support structure 180 is configured between the flexible substrate 10 and the flexible plane 12, as shown in FIG. 1. The support structure 180 is capable of forming a space between the first electrode 14 and the second electrode 16. In the embodiment of the present invention, the polarity of the second electrode and the polarity of the first electrode are different to each other, therefore, a capacitance is formed between the first electrode 14 and the second electrode 16.

As a user touches the contact surface 122 of the flexible plane 12 of the 3-D touch sensor 1, a force is applied on the contact surface 122, wherein the force can be further divided into a positive force and a lateral force, that is a force perpendicular to the contact surface 122 and a force parallel to the contact surface 122, wherein the lateral force can be seen as a shearing force. The shearing force applied on the contact surface 122 by the user is able to make the second electrode 16 have a displacement, the relative position is changed to the first electrode 14.

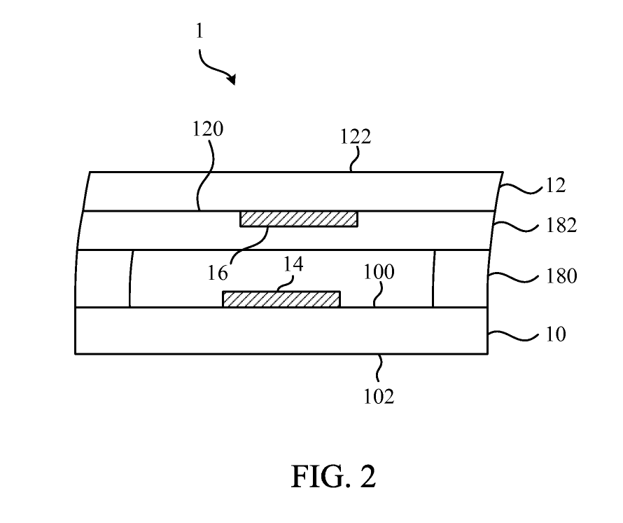

Please refer to FIG. 2. FIG. 2 is a schematic sectional diagram of the 3-D touch sensor of FIG. 1 applied a shearing force. As shown in FIG. 2, as the user touches the contact surface 122 and applies the shearing force on the contact surface 122, the flexible plane 12 is deformed because of the flexibility. The relative position between the second electrode 16 and the first electrode 14 is changed with the deformation of the flexible plane 12, furthermore, the value of the capacitance is changed with the change of the relative position.

In actual practice, a detecting unit can be configured for detecting the change of the capacitance value of the said embodiment, and the shearing force which the user applies on the contact surface 122 of the flexible plane 12 can be calculated according to an algorithm by a processing unit. As the result, the 3-D touch sensor 1 of the embodiment is capable of providing a touch sensing with more dimensions, therefore, the 3-D touch sensor is suitable for the touch of a 3D stereoscopic display.

Please refer to FIG. 1 and FIG. 2 again. As shown in FIG. 1 and FIG. 2, the 3-D touch sensor 1 further comprises an insulation layer 182 configured on the third surface 120 of the flexible plane 12, moreover, the insulation layer 182 covers the second electrode 16. The force applied on the contact surface 122 of the flexible plane 12 by the user, deforms the flexible plane 12 and displaces the second electrode 16. The insulation layer 182 makes that the second electrode 16 does not touch the first electrode 14 and become conductive as the second electrode 16 is displaced.

In the embodiment, the flexible substrate 10, the flexible plane 12, the support structure 180 and the insulation layer 182 of the 3-D touch sensor 1 are able to be made of transparent materials, such as PET or PDMS or other transparent polymer materials. Moreover, the first electrode 14 and the second electrode 16 are able to be made through a transparent conductive film process, such as ITO process. Based on the above materials, the 3-D touch sensor 1 of the embodiment is capable of having a good transmittance.

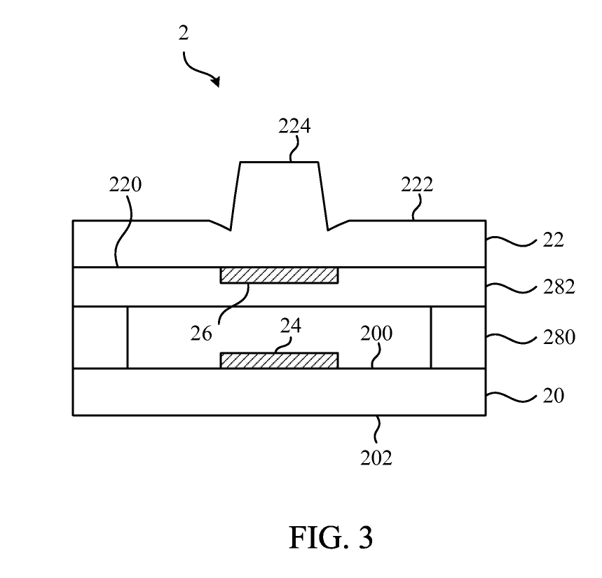

Please refer to FIG. 3 FIG. 3 is a schematic sectional diagram of the 3-D touch sensor of another embodiment of the present invention. As shown in FIG. 3, the difference between the embodiment and the said embodiment is that the flexible plane 22 of the 3-D touch sensor 2 of the embodiment further comprises a bump 224 configured on the contact surface 222. The user can touch the bump 224 and apply a lateral force on the contact surface 222 with the assistance of the bump 224, namely shearing force. The other units of the embodiment are broadly similar to the corresponding units of the said embodiment.

In actual practice, a plurality of 3-D touch sensors are able to be connected with each other and share the flexible plane and the flexible substrate, the bump is able to be configured between these 3-D touch sensors. As the user applies the shearing force on the flexible plane by the bump, as a result, the relative position between the second electrode and the bump of each 3-D touch sensor is different and the change of the relative position between each second electrode and the corresponding first electrode is different too, the change of the value of each capacitance is also different.

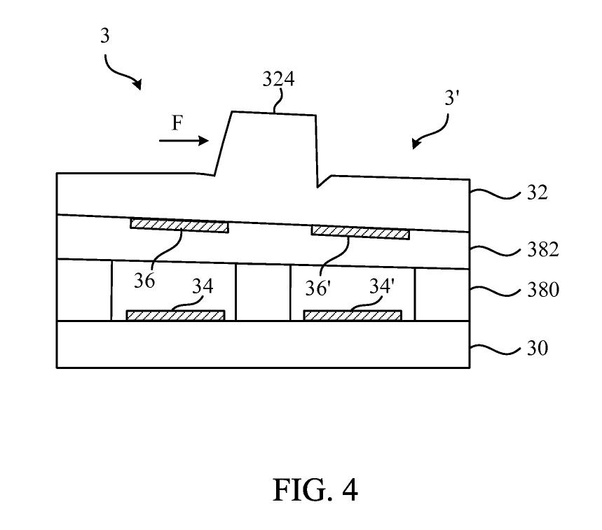

Please refer to FIG. 4. FIG. 4 is a schematic sectional diagram of the 3-D touch sensor of another embodiment of the present invention. as shown in FIG. 4, a 3-D touch sensor 3 and 3′ share a flexible substrate 30 and a flexible plane 32. A bump 324 is configured on the contact surface of the flexible plane 32, between a second electrode 36 of the 3-D touch sensor 3 and a second electrode 36′ of the 3-D touch sensor 3′. As the bump 324 is applied a lateral force F, the second electrode 36 is distant from a first electrode 34 and the second electrode 36′ is close to a first electrode 34′. Therefore, the 3-D touch sensor 3 and 3′ have different changes of the capacitance value.

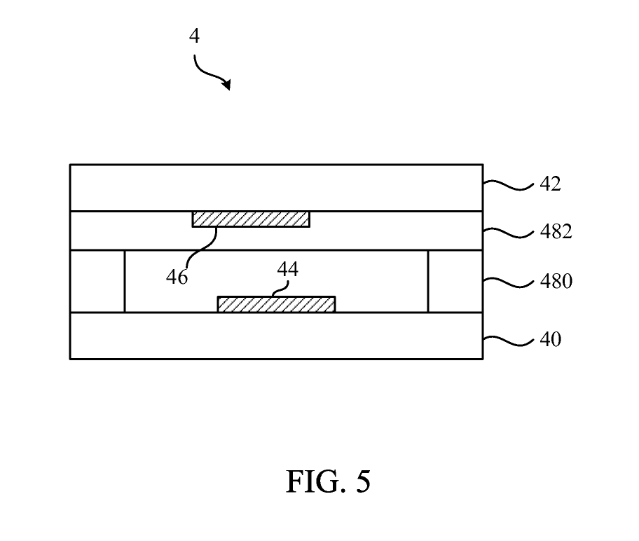

Please refer to FIG. 5. FIG. 5 is a schematic sectional diagram of the 3-D touch sensor of another embodiment of the present invention. As shown in FIG. 5, a 3-D touch sensor 4 comprises a flexible substrate 40, a flexible plane 42, a first electrode 44, a second electrode 46, a support structure 480 and an insulation layer 482. The difference of the embodiment and the said embodiment is that the second electrode 46 and the first electrode 44 of the embodiment are dislocated in arrangement. A shearing force applied by a user can displace the second electrode 46 as the user touches the contact surface of the flexible plane 42, as the same time, a change of the overlap area between the two electrodes can be detected in the direction from the flexible plane 42 to the flexible substrate 40, moreover, the change of the overlap area make the capacitance value change. The other units of the embodiment are broadly similar to the corresponding units of the said embodiment.

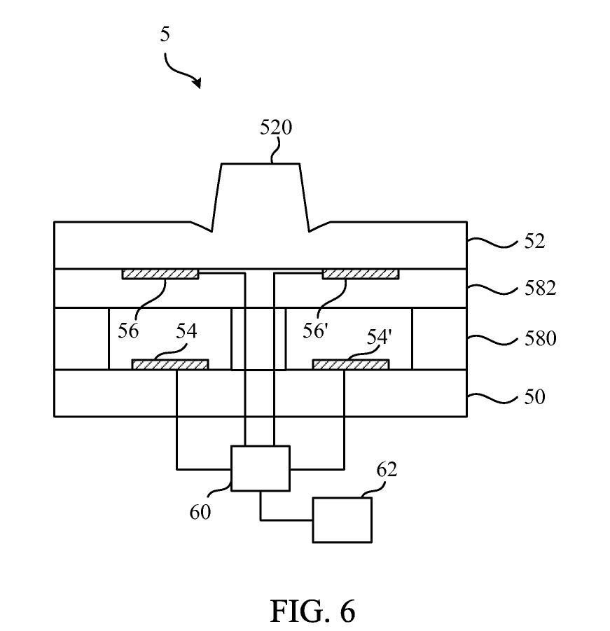

Please refer to FIG. 6. FIG. 6 is a schematic sectional diagram of the 3-D touch panel of another embodiment of the present invention. As shown in FIG. 6, a 3-D touch panel 5 comprises a flexible substrate 50, a flexible plane 52, a first electrode 54, a second electrode 56, a support structure 580, a insulation layer 582, a third electrode 54′, a fourth electrode 56′, a capacitance sensing unit 60 and a processing unit 62.

In the embodiment of the present invention, the flexible plane 52 is configured on the flexible substrate 50. The support structure 580 is configured between the flexible plane 52 and the flexible substrate 50. The first electrode 54 and the second electrode 56 are configured on the flexible substrate 50 and the flexible plane 52 respectively and correspondingly, similarly, the third electrode 54′ and the fourth electrode 56′ are configured on the flexible substrate 50 and the flexible plane 52 respectively and correspondingly. The support structure 580 forms a space between the first electrode 54 and the second electrode 56, and also forms another space between the third electrode 54′ and the fourth electrode 56′. The insulation layer 582 is configured on the flexible plane 52 and covers the second electrode 56 and 56′. The polarity of the second electrode 56 and the polarity of the first electrode 54 are different to each other, and therefore a first capacitance is formed between the second electrode 56 and the first electrode 54. Similarly, a second capacitance is formed between the third electrode 54′ and the fourth electrode 56′. The capacitance sensing unit 60 is electrically connected to the electrodes for sensing the value of the capacitance. The processing unit 62 is electrically connected to the capacitance sensing unit 60, and can receive the capacitance values measured by the capacitance sensing unit 60.

A shearing force applied by a user deforms the flexible plane 52 and displaces the second electrode 56 as the user touches the flexible plane 52, the value of the first capacitance is changed with the change of the relative position between the second electrode 56 and the first electrode 54. Similarly, the value of the second capacitance is changed with the change of the relative position between the fourth electrode 56′ and the third electrode 54′. After the processing unit 62 receives the changes of the capacitance values from the capacitance sensing unit 60, the processing unit 62 is able to calculate the quantity and the direction of the shearing force applied by the user according to the change of the capacitance value and an algorithm. Therefore, the 3-D touch panel 5 of the embodiment is capable of providing a touch sensing with more dimensions, in other words, the 3-D touch panel is suitable for the touch of a 3D stereoscopic display.

Please refer to FIG. 6 again. The flexible plane 52 further comprises a bump 520 for assisting the user with the shearing force on the flexible plane 52. Moreover, the first electrode 54 and the second electrode 56 are in a first dislocation arrangement, and the third electrode 54′ and the fourth electrode 56′ are in a second dislocation arrangement. The difference between the first dislocation arrangement and the second dislocation arrangement of the embodiment is that the deviating directions of the second electrode 56 and fourth electrode 56′ are different, as shown in FIG. 6.

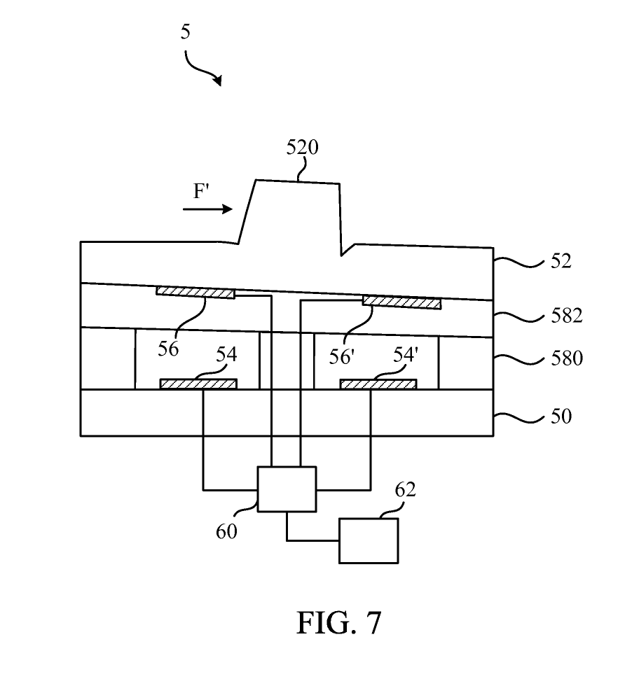

Please refer to FIG. 7. FIG. 7 is a schematic sectional diagram of the bump of the 3-D touch panel of FIG. 6 contacted by a user. As shown in FIG. 7, as the user applies a lateral force F′ to the bump 520, the second electrode 56 is displaced with the deformation of the flexible plane 52, as a result, the original deviating direction of the second electrode 56 is opposite to the displacing direction, the increase of the overlap area between the second electrode 56 and the first electrode 54 is able to be detected in the direction from the flexible plane 52 to the flexible substrate 50. Relatively, the original deviating direction of the fourth electrode 56′ is similar to the displacing direction, the decrease of the overlap area between the fourth electrode 56′ and the third electrode 54′ is able to be detected.

As mentioned above, as the user applies a lateral force F′ to the bump 520, the first capacitance and the second capacitance have a various change of capacitance value respectively. The processing unit 62 is able to receive the changes of the capacitance values from the capacitance sensing unit 60, calculate the change of the overlap areas between each electrodes set, which are the first electrode and the corresponding second electrode, according to the change of the capacitance value and the algorithm, and further calculate the lateral force F′ applied by the user, that is the shearing force. In actual practice, the electrodes dislocated in arrangement are able to increase the shearing force sensitivity of the 3-D touch panel of the embodiment.

In the embodiment of the present invention, the flexible substrate 50, the flexible plane 52, the support structure 580 and the insulation layer 582 of the 3-D touch panel 5 are able to be made of transparent polymer materials. The first electrode 54, the second electrode 56, the third electrode 54′ and the fourth electrode 56′ are able to be made through a transparent conductive film process, such as ITO process, therefore, the 3-D touch panel 5 is capable of having a good transmittance and suitable for a 3D stereoscopic display with stereographic projection.

In the other hand, based on the 3-D touch sensor and the 3-D touch panel of the present invention used flexible materials as the substrate, the 3-D touch panel of the present invention is capable of having individual touch and reaching the function of touch with an electronic device with non-touch. For example, for a 3-D stereoscopic display with non-touch, the projection panel is able to attach the 3-D touch panel of the present invention. The stereoscopic image projected by the projection panel is able to pass through the 3-D touch panel and can be touched by the 3-D touch panel.

In summary, the 3-D touch sensor and the 3-D touch panel of the present invention utilize the deformation of the flexible substrate and the flexible plane corresponding to the shearing force to change the capacitance value, and calculate the shearing force on the 3-D touch panel according to the difference of the capacitance value and an algorithm, and further provide a touch sensing with more dimensions. Moreover, the 3-D touch sensor and the 3-D touch panel of the present invention have a good transmittance for attaching a 3D stereoscopic display, and reach the purpose of touching the stereoscopic image projected by the 3D stereoscopic display.

Although the present invention has been illustrated and described with reference to the preferred embodiment thereof, it should be understood that it is in no way limited to the details of such embodiment but is capable of numerous modifications within the scope of the appended claims.

What is claimed is:

1. A 3-D touch sensor, comprising:
a flexible substrate, having a first surface and a second surface relative to the first surface;
a flexible plane, configured on the flexible substrate, having a third surface faced to the flexible substrate and a contact surface relative to the third surface for a user to touch thereon;
a support structure, configured between the flexible plane and the flexible substrate for forming a space between the flexible plane and the flexible substrate;
a first electrode, configured on the first surface of the flexible substrate; and
a second electrode, configured on the third of the flexible plane relative to the first electrode, the polarity of the second electrode different to the polarity of the first electrode and a capacitance formed between the second electrode and the first electrode.

2. The 3-D touch sensor of claim 1, wherein the first electrode and the second electrode are dislocated in arrangement.

3. The 3-D touch sensor of claim 1, further comprising a bump, configured on the contact surface of the flexible plane for assisting the user with a force parallel to the contact surface on the contact surface.

4. The 3-D touch sensor of claim 1, further comprising an insulation layer, configured on the third of the flexible plane, covering the second electrode.

5. The 3-D touch sensor of claim 4, wherein the flexible substrate, the flexible plane, the support structure and the insulation layer are made of transparent polymer materials.

6. The 3-D touch sensor of claim 5, wherein the first electrode and the second electrode are made of transparent conductive films.

7. A 3-D touch panel, comprising:
a flexible substrate, having a first surface and a second surface relative to the first surface;
a flexible plane, configured on the flexible substrate, having a third surface faced to the flexible substrate and a contact surface relative to the third surface for a user to touch thereon;
a support structure, configured between the flexible plane and the flexible substrate for forming a space between the flexible plane and the flexible substrate;
a first electrode, configured on the first surface of the flexible substrate;
a second electrode, configured on the third of the flexible plane relative to the first electrode, the polarity of the second electrode different to the polarity of the first electrode and a first capacitance formed between the second electrode and the first electrode;
a capacitance sensing unit, electrically connected to the first electrode and the second electrode, for sensing the value of the first capacitance; and
a processing unit, electrically connected to the capacitance sensing unit, calculating a shearing force parallel to the contact surface, which the user applies on the contact surface, according to the difference of the capacitance value and an algorithm.

8. The 3-D touch panel of claim 7, wherein the first electrode and the second electrode are in a first dislocation arrangement.

9. The 3-D touch panel of claim 8, further comprising:
a third electrode, configured on the first surface of the flexible substrate; and
a fourth electrode, configured on the third surface of the flexible plane in a second dislocation arrangement relative to the third electrode, the polarity of the fourth electrode different to the polarity of the third electrode and a second capacitance formed between the fourth electrode and the third electrode.

10. The 3-D touch panel of claim 7, further comprising a bump, configured on the contact surface of the flexible plane for assisting the user with a force parallel to the contact surface on the contact surface.
